(19) United States
(12) Patent Application Publication
(10) Pub. No.: US 2026/0138897 A1
(43) Pub. Date: May 21, 2026

(54) FLUORINE-FREE POLYIMIDE-BASED MEMBRANE FOR WATER TREATMENT

(71) Applicant: KING FAHD UNIVERSITY OF PETROLEUM AND MINERALS, Dhahran (SA)

(72) Inventor: Mahmoud Atef ABDULHAMID, Dhahran (SA)

(73) Assignee: KING FAHD UNIVERSITY OF PETROLEUM AND MINERALS, Dhahran (SA)

(21) Appl. No.: 18/952,692

(22) Filed: Nov. 19, 2024

(51) Int. Cl. C02F 1/44; C02F 1/00; C02F 101/32

(52) U.S. Cl. CPC C02F 1/444; C02F 1/001; C02F 2101/322; C02F 2303/16

(57) ABSTRACT

A method of water treatment includes treating a mixture of water and oil with a membrane that includes a polyimide formed by polycondensation between 4,4′-(4,4′-isopropylidenediphenoxy)bis-(phthalic anhydride) (BPADA) and 2,4,6-trimethyl-m-phenylenediamine (TrMPD). The polyimide does not include fluorine. The polyimide is in the form of fibers having an average diameter of 0.5 micrometers (μm) to 5.0 μm, and the fibers are bead-free and are formed by electrospinning to form a membrane having pores with an average size of 2 μm to 10 μm.

### STATEMENT REGARDING PRIOR DISCLOSURE BY THE INVENTORS

Aspects of the present disclosure are described in “Electrospun nanofibrous membranes based on fluorine-free polyimide for swift oil spill cleanup and emulsion separation” Separation and Purification Technology, 354 (2025) 129189, which is incorporated herein by reference in its entirety.

### STATEMENT OF ACKNOWLEDGEMENT

The inventor would like to thank King Fahd University of Petroleum and Minerals (KFUPM) for supporting this work under INMW2418. The inventor thanks Ibtisam Bin Sharfan and Zainah AlDhawi for the valuable discussions.

### BACKGROUND

### Technical Field

The present disclosure is generally directed to water treatment techniques, and more particularly, relates to a method of water treatment with a membrane.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

With the advancement of civilisation and industrialisation, pollution has increased in various aspects. One such major challenge is water pollution, refraining a large population from getting clean water. Water pollution is driven by domestic waste, industrial wastewater, oil leakage, etc. Oily wastewater, especially from oil spills during petroleum operations, is a significant contributor to oceanic water pollution. Oil contaminants may remain in the marine environment for years, depending on their properties, leading to prolonged damage. Oil spills are greatly toxic to the marine ecosystem and to human health. The wastewater expelled by oil processing facilities poses a serious threat to aquatic life. Spilled oil may harm the quality of air, water, sediments, soil, and biota on different levels due to its ability to explode and evaporate. Therefore, sustainable industrial development requires scientific, environmental, and economic efforts to mitigate the pollution from oil production and address oil spill accidents with effective oil removal methods.

Oily wastewater can be treated using methods like adsorption, dissolved air flotation, coagulation, centrifugation, gravity separation, and biological treatment. However, these technologies face limitations such as low removal efficiency, high costs, energy consumption and production of contaminated waste. The rapid growth in separation technologies has resulted in the development of various membranes that can overcome the shortcomings of other treatment methods due to their low energy requirements, high separation efficiency, and small footprint. Hence, substantial research efforts have been focused on enhancing the properties of membranes either via developing novel materials or introducing surface modifications for conventional membranes (Y. Yu and coworkers, Selective separation of oil and water with mesh membranes by capillarity, Adv colloid interface sci, 2016, 235, 46-55).

Membrane technology is desirable for oily wastewater treatment, with polymer membranes achieving over 99% removal of insoluble oil. Advantages include high separation efficiency for fine oil-water emulsions, elimination of additional chemicals, energy efficiency, and compact, modular equipment. However, high capital costs for large volumes and membrane fouling and degradation during long-term use limit further applications. The foulant removal process significantly reduces the membranes lifetime, compounded by their relatively poor thermal stability and chemical resistance. These limitations highlight the need for polymeric membranes with enhanced stability and fouling resistance.

Researchers have developed polymer membranes for effective oil-water separation, with indicators like permeability and fouling resistance. Polymer membranes possess strong resistance to ageing, which ensures durability in wastewater treatment. Aromatic polyimides (PI) are gaining attention for electrospun nanofibrous membranes used in water remediation and oil spill recovery due to their excellent physical, chemical, and mechanical properties, along with high thermal stability attributed to their rigid molecular structure (M. Mehrabi and V. Vatanpour, Polyimide-based separation membranes for liquid separation: A review on fabrication techniques, applications, and future perspectives, Mater Today Chem, 2024, 35, 101895).

Fluorine has been used in polyimide membranes to enhance properties like chemical resistance and hydrophobicity. However, this fluorine approach has notable drawbacks. The fluorinated components can negatively affect the thermal stability of polyimides, limiting their effectiveness in high-temperature applications.

Accordingly, it is one object of the present disclosure to develop a fluorine-free polyimide-based membrane for treating a mixture of water and oil to overcome the limitations of methods known in the art.

### SUMMARY

In an exemplary embodiment, a method of water treatment is described. The method includes treating a mixture of water and oil with a membrane that includes a polyimide formed by polycondensation between 4,4′-(4,4′-isopropylidenediphenoxy)bis-(phthalic anhydride) (BPADA) and 2,4,6-trimethyl-m-phenylenediamine (TrMPD). The polyimide does not include fluorine. The polyimide is in the form of fibers having an average diameter of 0.5 micrometers (μm) to 5.0 μm, and the fibers are bead-free and form pores having an average size of 2 μm to 10 μm.

In some embodiments, the treating the mixture with the membrane includes soaking the membrane in the mixture for a period of 0.1 minute to 5.0 minutes to absorb 10 grams (g) to 40 g of the oil from the mixture per 1 g of the membrane and removing the membrane from the mixture to obtain purified water.

In some embodiments, about 35.5 g of the oil per 1 g of the membrane is absorbed from the mixture by the membrane for the period of 2 minutes.

In some embodiments, the method further includes forming the membrane by electrospinning a solution including the polyimide on a drum at a rotating speed of 0-500 rpm. The treating includes contacting the mixture with the membrane to pass an oil-free permeate through the membrane, and a back surface of the membrane is supported on a loose particle filter.

In some embodiments, the solution further includes dimethylformamide as a solvent, the polyimide is present at a concentration of 15 percent by weight (wt. %) to 25 wt. % based on a total weight of the solution, and the rotating speed is 0 revolution per minute (rpm) to 150 rpm.

In some embodiments, the polyimide is present at a concentration of 20 wt. % based on the total weight of the solution, and the rotating speed is 150 rpm.

In some embodiments, a volage of the electrospinning is 16 kilovolts (kV), an injection rate of the electrospinning is 0.5 milliliters per hour (mL/h), a tip-to-collector distance is 10 cm, and a temperature of the electrospinning is 21° C.

In some embodiments, the membrane has an oil contact angle of about 0°.

In some embodiments, the membrane has a water contact angle of 110° or more and 160° or less.

In some embodiments, the polyimide has a weight molecular weight of 40,000 grams per mole (g/mol) to 80,000 g/mol.

In some embodiments, the polyimide includes 70 percent by mass (mass %) to 100 mass % of repeating units based on 4,4′(4,4′-isopropylidenediphenoxy)bis-(phthalic anhydride) (BPADA) and 2,4,6-trimethyl-m-phenylenediamine (TrMPD), relative to a total weight of repeating units of the polyimide.

In some embodiments, the polyimide includes 100 mass % of repeating units based on 4,4′-(4,4′-isopropylidenediphenoxy)bis-(phthalic anhydride) (BPADA) and 2,4,6-trimethyl-m-phenylenediamine (TrMPD), relative to the total weight of the repeating units of the polyimide.

In some embodiments, the polyimide has no carboxylic group.

In some embodiments, the polyimide includes 0 mass % to 5 mass % of repeating units based on benzoxazole, benzimidazole, benzothiazole, 4,4′-biphenyltetracarboxylic acid dianhydride, 4,4′-diaminodiphenyl ether, polybenzoxazine, silica nanoparticles, p-phenylene diamine or a combination thereof, relative to a total weight of repeating units of the polyimide.

In some embodiments, the polyimide does not include repeating units based on benzoxazole, benzimidazole, benzothiazole, 4,4′-biphenyltetracarboxylic acid dianhydride, 4,4′-diaminodiphenyl ether, polybenzoxazine, silica nanoparticles or p-phenylene diamine.

In some embodiments, the membrane includes 0 mass % to 10 mass % of nanoparticles of oxides, metallic compounds or both, relative to a total weight of the membrane.

In some embodiments, the treating the mixture with the membrane includes filtering the mixture through the membrane to generate a water permeate.

In some embodiments, the filtering includes pouring the mixture onto the membrane under atmospheric pressure.

In some embodiments, the method further includes mechanically regenerating the membrane by squeezing the membrane after the treating, treating another mixture of water and oil with the membrane after the mechanically regenerating.

In some embodiments, the mixture includes hexane, dodecane, crude oil, brackish water or a combination thereof.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings.

FIG. 1 depicts an exemplary schematic route for synthesizing a polyimide by polycondensation between 4,4′-(4,4′-isopropylidenediphenoxy)bis-(phthalic anhydride) (BPADA) and 2,4,6-trimethyl-m-phenylenediamine (TrMPD), according to certain embodiments.

FIG. 2A shows a proton nuclear magnetic resonance (¹H NMR) spectroscopy of poly(BPADA-TrMPD) (also noted as BPADA-TrMPD), according to certain embodiments.

FIG. 2B shows a Fourier transform infrared spectroscopy (FTIR) spectrum of BPADA-TrMPD, according to certain embodiments.

FIG. 2C depicts thermogravimetric-differential thermal analysis (TGA-DTA) of BPADA-TrMPD, according to certain embodiments.

FIG. 2D shows wide angle X-ray diffraction (WXRD) patterns of BPADA-TrMPD, according to certain embodiments.

FIG. 3A shows a scanning electron microscope (SEM) image at 50 micrometers (μm) magnification, for fiber diameter of BPADA-TrMPD-based electro spun nanofibrous membrane (M1), according to certain embodiments.

FIG. 3B shows an SEM image at 10 μm magnification, for fiber diameter distribution of membrane M1, according to certain embodiments.

FIG. 3C shows the oil contact angle (OCA) measured in dynamic mode over 1 second for membrane M1, according to certain embodiments.

FIG. 3D shows an SEM image at 50 μm magnification, for fiber diameter distribution of BPADA-TrMPD based electro spun nanofibrous membrane M2, according to certain embodiments.

FIG. 3E shows an SEM image at 10 μm magnification, for fiber diameter distribution of membrane M2, according to certain embodiments.

FIG. 3F shows the oil contact angle (OCA) measured in dynamic mode over 1 second for membrane M2, according to certain embodiments.

FIG. 4A depicts a dynamic water contact angle measurement for membrane M1 at 0 second, 0.06 second, 0.5 second, and 1 second, respectively, according to certain embodiments.

FIG. 4B depicts a dynamic water contact angle measurement for membrane M2 at 0 second, 0.06 second, 0.5 second, and 1 second, according to certain embodiments.

FIG. 4C depicts a dynamic crude oil contact angle measurement for membrane M1 at 0 second, 0.06 second, 0.5 second, and 1 second, according to certain embodiments.

FIG. 4D depicts a dynamic crude oil contact angle measurement for membrane M2 at 0 second, 0.06 second, 0.5 second, and 1 second, according to certain embodiments.

FIG. 5A is a graph of performance characteristics of BPADA-TrMPD based membranes showing time-dependent sorption kinetics for membrane M1 and membrane M2 after two minutes of immersion, according to certain embodiments.

FIG. 5B is a graph of performance characteristics of BPADA-TrMPD based membranes showing flux performance using membrane M2 after two minutes of immersion, according to certain embodiments.

FIG. 5C shows images depicting emulsion separation of oil from water in an oil-water (o/w) emulsion with an o/w ratio of 99/1, for membrane M2, according to certain embodiments.

FIG. 5D shows images depicting emulsion separation of oil from water in an o/w emulsion with an o/w ratio of 90/10, for membrane M2, according to certain embodiments.

FIG. 6A is a graph depicting potential of mechanical regeneration in order to enable repeated use of membrane M1 and membrane M2 in crude oil removal, according to certain embodiments.

FIG. 6B depicts optical images of the membrane M1 and the membrane M2, before and after 5 cycles of regeneration, according to certain embodiments.

FIG. 6C is an SEM image of the membrane M1 after regeneration, including fiber diameter in inset, according to certain embodiments.

FIG. 6D is an SEM image of the membrane M2 after regeneration, including fiber diameter in inset, according to certain embodiments.

FIG. 6E shows optical images depicting before, on contact and after crude oil removal from the surface of water using BPADA-TrMPD based membrane M2, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “water treatment” refers to a process or method aimed at removing one or more contaminants, pollutants, or impurities from water to make it suitable for a specific purpose, such as industrial use, environmental cleanup, or safe consumption. This process can involve the separation of oil, organic compounds, or other hazardous materials from water using various filtration, sorption, or purification techniques, including the use of specialized membranes or other technologies to achieve clean and treated water.

As used herein, the term “polycondensation” refers to a chemical reaction process in which two or more monomers react to form a polymer, typically accompanied by the release of a small molecule, such as water or methanol. This process often involves the formation of bonds between functional groups, resulting in the creation of high molecular-weight polymers. Polycondensation is commonly used to synthesize various polymers, including polyimides and polyesters. It is characterized by its ability to produce materials with specific properties tailored for applications in fields such as materials science, engineering, and nanotechnology.

As used herein, the term “electrospinning” refers to a versatile fabrication technique used to produce fine fibers from a polymer solution or melt under the influence of an electric field. In this process, a voltage is applied to a liquid droplet at the tip of a nozzle, which creates an electric field that overcomes the surface tension of the droplet. This results in the formation of a charged jet that elongates and thins as it travels toward a grounded collector, such as a drum or plate. The solvent evaporates during this journey, leading to the deposition of solid polymer fibers. Electrospinning is widely used to create nanofibrous mats with high surface area-to-volume ratios, which are applicable in various fields, including filtration, tissue engineering, drug delivery, and protective coatings.

As used herein, the term “crude oil” refers to a naturally occurring, unrefined petroleum product composed of a complex mixture of hydrocarbons and other organic materials. It is found in geological formations beneath the Earth's surface and can vary widely in composition, density, and viscosity depending on its source. Crude oil is a primary raw material for producing various fuels, including gasoline, diesel, and jet fuel, as well as other petrochemicals used in manufacturing plastics, synthetic materials, and chemicals. Its properties and quality are often assessed based on its specific gravity, sulfur content, and the presence of various fractions, which influence its value and suitability for refining processes.

Aspects of this disclosure are directed to fluorine-free polyimide nanofibrous membranes for water treatment. The membrane of the present disclosure is highly absorbent and hydrophobic and exhibits excellent flux rates, allowing for quick separation of oil from water. This method provides an eco-friendly, efficient, and sustainable solution for treating water contaminated with oil and organic compounds. The water treatment method of the present disclosure offers significant advantages, particularly for oil spill cleanup and industrial wastewater management.

A method of water treatment is described. The method includes treating a mixture of water and oil with a membrane that includes a polyimide formed by polycondensation between 4,4′-(4,4′-isopropylidenediphenoxy)bis-(phthalic anhydride) (BPADA) and 2,4,6-trimethyl-m-phenylenediamine (TrMPD). In polycondensation reaction, 4,4′-(4,4′-isopropylidenediphenoxy)bis-(phthalic anhydride) (BPADA) and 2,4,6-trimethyl-m-phenylenediamine (TrMPD) react through the condensation of their functional groups-anhydride and amine, respectively. The anhydride groups of BPADA react with the amine groups of TrMPD, forming amide linkages and releasing small molecules such as water as byproducts. Polyimides formed via polycondensation are known for their exceptional mechanical strength, thermal stability, and chemical resistance, properties important for the performance of the membrane in separating oil from water.

In some embodiments, the polyimide may include 70 to 100 mass % (e.g. 70 mass %, 75 mass %, 80 mass %, 85 mass %, 90 mass %, 95 mass %, 100 mass % or any values therebetween) of repeating units based on 4,4′-(4,4′-isopropylidenediphenoxy)bis-(phthalic anhydride) (BPADA) and 2,4,6-trimethyl-m-phenylenediamine (TrMPD), relative to a total weight of repeating units of the polyimide. In a preferred embodiment, the polyimide has 100 mass % of repeating units based on BPADA and TrMPD, relative to the total weight of the repeating units of the polyimide.

In some embodiments, the polyimide may include 0 to 30 mass % (e.g. 0 mass %, 1 mass %, 2 mass %, 5 mass %, 10 mass %, 20 mass %, 30 mass % or any values therebetween) of repeating units based on benzoxazole, benzimidazole, benzothiazole, 4,4′-biphenyltetracarboxylic acid dianhydride, 4,4′-diaminodiphenyl ether, polybenzoxazine, silica nanoparticles, p-phenylene diamine or a combination thereof, relative to the total weight of repeating units of the polyimide. In a preferred embodiment, the polyimide does not include repeating units based on benzoxazole, benzimidazole, benzothiazole, 4,4′-biphenyltetracarboxylic acid dianhydride, 4,4′-diaminodiphenyl ether, polybenzoxazine, silica nanoparticles or p-phenylene diamine.

In some embodiments, the polyimide may include 0 to 30 mass % (e.g. 0 mass %, 1 mass %, 2 mass %, 5 mass %, 10 mass %, 20 mass %, 30 mass % or any values therebetween) of repeating units based on additional dianhydrides and/or diamines. Such additional dianhydrides can include pyromellitic dianhydride (PMDA), 3,3′,4,4′-benzophenonetetracarboxylic dianhydride (BTDA), 4,4′-oxydiphthalic anhydride (ODPA), 4,4′-sulfonyldiphthalic anhydride (SDPA), biphenyltetracarboxylic dianhydride (BPDA), 3,3′,4,4′-diphenyl ether tetracarboxylic dianhydride (ODTDA), perfluorobiphenyl tetracarboxylic dianhydride (PFDA), and hexafluoroisopropylidene diphthalic anhydride (6FDA). Such additional diamines may include 4,4′-oxydianiline (ODA), m-phenylenediamine (mPDA), p-phenylenediamine (pPDA), 4,4′-diaminodiphenyl sulfone (DDS), 2,2-bis(4-aminophenyl) hexafluoropropane (6F-DAB), 1,3-bis(4-aminophenoxy)benzene (TPE-R), 3,3′-diaminobenzidine (DAB), 1,4-bis(4-aminophenoxy)benzene (APB), 2,2′-bis(trifluoromethyl)benzidine (TFMB), 4,4′-methylenedianiline (MDA), 1,3-diaminobenzene (m-xylylenediamine), and 4,4′-diaminodiphenylmethane (MDA). In a preferred embodiment, the polyimide includes 0 to 5 mass % of the additional dianhydrides and/or diamines.

In some embodiments, the polyimide may include 0 to 10 mass % (e.g. 0 mass %, 1 mass %, 2 mass %, 5 mass %, 10 mass % or any values therebetween) of repeating units based on fluorine-containing monomers such as 2,2-bis(3,4-dicarboxyphenyl) hexafluoropropane dianhydride (6FDA), perfluorobiphenyl tetracarboxylic dianhydride (PFDA), 4,4′-hexafluoroisopropylidene bis(phthalic anhydride) (6FPA), hexafluorobenzene tetracarboxylic dianhydride (HFBDA), 2,2′-bis(trifluoromethyl)benzidine (TFMB), 1,1,1,3,3,3-hexafluoro-2,2-bis(4-aminophenyl) propane (6F-DAB), 3,3′-bis(trifluoromethyl)-4,4′-diaminodiphenylmethane (TFMDA), 4,4′-(hexafluoroisopropylidene)bis(phthalic anhydride) (6F-ODA), and 4,4′-(hexafluoroisopropylidene)dianiline (6F-ODA). In a preferred embodiment, the polyimide does not include fluorine or fluorine-containing monomers. The absence of fluorine simplifies the polymer structure, potentially reducing the material's overall cost and environmental impact, as fluorine-based chemicals can sometimes pose challenges in terms of sustainability and toxicity. Moreover, non-fluorinated polyimides may exhibit better compatibility with other materials or environments where fluorine is undesirable, such as in certain biomedical or food-related applications. Additionally, non-fluorinated polyimides can offer excellent thermal and mechanical performance while providing good separation efficiency in oil-water filtration due to their inherent chemical resistance and durability.

In some embodiments, the polyimide can contain carboxylic groups. In a preferred embodiment, the ¹H-NMR spectroscopy confirms the absence of peaks in the region above 10 ppm that indicate the absence of the acidic O—H protons of carboxylic groups and confirms the full conversion of poly (amic acid) to polyimide. Polyimides are formed by polycondensation of dianhydrides and diamines, converting poly(amic acid) into a fully imidized structure, eliminating carboxylic groups. The resulting imide rings provide high thermal stability, chemical resistance, and mechanical strength, making polyimides suitable for demanding environments like high-temperature or aggressive conditions. The absence of carboxylic groups reduces hydrophilicity, enhancing their performance in applications like oil-water separation.

In some embodiments, the polyimide may have a molecular weight ranging from 40,000 to 80,000 g/mol, e.g. 40,000 g/mol, 50,000 g/mol, 60,000 g/mol, 70,000 g/mol, 45,000 g/mol, 65,000 g/mol, 80,000 g/mol or any values therebetween. In a preferred embodiment, the polyimide has a molecular weight of 54,500 g/mol.

The morphology of the polyimide membrane can be structurally characterized using scanning electron microscopy (SEM) analysis. The membrane may exhibit a range of morphological shapes, including, but not limited to, nanocrystals, nanorectangles, nanotriangles, nanopentagons, nanohexagons, nanoprisms, nanodisks, nanocubes, nanoribbons, nanoblocks, nanobeads, nanoflakes, nanopowders, and nanoflowers, as well as mixtures thereof. In a preferred embodiment, the polyimide is in the form of fibers and is porous. The fibers are bead-free. The membrane exhibits the ability to be folded without experiencing any cracks, demonstrating structural stability even under deformation, likely attributed to the high molecular weight of the BPADA-TrMPD polymer.

In some embodiments, the polyimide fibers may have an average diameter ranging from 0.5-5.0 μm, e.g. 0.5 μm, 1 μm, 2 μm, 3 μm, 4 μm, 1.5 μm, 3.5 μm, 5.0 μm or any values therebetween. In a preferred embodiment, the polyimide fiber has an average diameter of 1.4±0.6 μm.

In some embodiments, the polyimide fibers may form pores that have an average size ranging from 2 to 10 μm, e.g. 2 μm, 4 μm, 6 μm, 8 μm, 3μm, 7 μm, 9 μm, 10 μm or any values therebetween.

The membrane is formed by electrospinning a solution, including the polyimide on a drum. In some embodiments, the solution may include one or more solvents such as polar aprotic and protic solvents that can dissolve polyimides or assist in the electrospinning process. Some common solvent options include dimethylformamide (DMF), N-methyl-2-pyrrolidone (NMP), dimethyl sulfoxide (DMSO), tetrahydrofuran (THF), acetonitrile, acetone, chloroform, methylene chloride, ethyl acetate, 1,4-dioxane, ethanol, propylene carbonate, isopropanol, butanol, formic acid, trifluoroacetic acid, toluene, benzene, xylene, cyclohexanone, and hexafluoroisopropanol (HFIP). In a preferred embodiment, the solution includes dimethylformamide (DMF) as a solvent. DMF ensures the polyimide is uniformly dissolved, creating a homogeneous solution suitable for electrospinning. Its high boiling point allows for the controlled evaporation of the solvent during the spinning process, which is essential for fiber formation.

In some embodiments, the polyimide may be present at a concentration ranging from 15-25 wt. %, e.g. 15 wt. %, 17 wt. %, 19 wt. %, 21 wt. %, 23 wt. %, 25 wt. % or any values therebetween, based on a total weight of the solution used for electrospinning. In a preferred embodiment, the polyimide is present at a concentration of 20 wt. % based on the total weight of the solution.

In some embodiments, the electrospinning may be performed at a rotating speed ranging from 0 to 500 rpm, e.g. 0 rpm, 100 rpm, 150 rpm, 200 rpm, 250 rpm, 300 rpm, 350 rpm, 400 rpm, 450 rpm, 500 rpm or any values therebetween. In a preferred embodiment, the electrospinning process is carried out at a rotating speed of 150 rpm.

In some embodiments, the voltage during the electrospinning process may range from 5-20 kV, e.g. 5 kV, 7 kV, 9 kV, 11 kV, 13 kV, 15 kV, 17 kV, 20 kV or any values therebetween. In a preferred embodiment, the voltage of electrospinning is 16 kV.

In some embodiments, the injection rate during the electrospinning process may range from 0.1 mL/h to 1 mL/h e.g. 0.1 mL/h, 0.3 mL/h, 0.5 mL/h, 0.7 mL/h, 0.9 mL/h, 1 mL/h or any values therebetween. In a preferred embodiment, the injection rate is about 0.5 mL/h.

In some embodiments, a tip-to-collector distance may range from 5-50 cm, e.g. 5 cm, 30 cm, 20 cm, 10 cm, 25 cm, 35 cm, 45 cm, 15 cm, 50 cm or any values therebetween. In a preferred embodiment, the tip-to-collector distance is 10 cm.

In some embodiments, the temperature during the electrospinning process may range from 10-50° C., e.g. 10° C., 30° C., 20° C., 45° C., 35° C., 25° C., 50° C. or any values therebetween. In a preferred embodiment, the temperature of the electrospinning is 21° C.

In some embodiments, the membrane has an oil contact angle ranging from 0° to 10°, e.g. 0°, 4°, 3°, 2°, 1°, 4.5°, 3.5°, 2.5°, 5°, 8°, 10° or any values therebetween. In a preferred embodiment, the membrane has an oil contact angle of 0°.

In some embodiments, the membrane may have a water contact angle ranging from 110-160°, e.g. 110°, 120°, 130°, 140°, 150°, 160° or any values therebetween. In a preferred embodiment, the membrane has a water contact angle of 114°.

In some embodiments, the membrane may include 0-10 mass % (e.g. 0 mass %, 2 mass %, 4 mass %, 6 mass %, 8 mass %, 10 mass % or any values therebetween) of nanoparticles of oxides, metallic compounds or both, relative to the total weight of the membrane.

In some embodiments, treating the mixture with the membrane includes soaking the membrane in the mixture. The soaking process allows the membrane to absorb or interact with the components of the mixture.

In some embodiments, the membrane is soaked in the mixture for 0.1 to 5.0 minutes (e.g. 0.1 minute, 0.2 minute, 0.5 minute, 1.0 minute, 4.0 minutes, 3.0 minutes, 2.0 minutes, 5.0 minutes or any values therebetween) to form a soaked membrane. In a preferred embodiment, the membrane is soaked in the solution for 2 minutes. The soaked membrane may absorb about 10 to 40 grams (e.g. 10 grams, 30 grams, 20 grams, 35 grams, 25 grams, 40 grams or any values therebetween) of oil from the mixture per 1 gram of the membrane. In a preferred embodiment, the soaked membrane absorbs about 35.5 grams of oil per 1 gram of the membrane from the mixture.

After the membrane has been soaked and absorbed the desired contaminants or impurities, the membrane is lifted from the mixture, allowing the liquid to drain out. This action leaves behind the contaminants that are captured by the membrane, while the remaining liquid, now enriched with purified water, can be collected for further use or analysis.

In a preferred embodiment of the invention, a liquid mixture including water and oil is passed through the membrane and a supporting structure in the form of a sand core or loose sand/particle filter that is in continuous but not permanently bonded contact with a back surface of the membrane. Substantially all of the oil present in the mixture is captured by the membrane as the mixture passes therethrough. A purified permeate exits the back side of the membrane and then passes through the sand core or sand/particle filter. Due to the ability of the membrane to capture and hold oil, the sand filter/support may be agitated with a backflow of the permeate or another liquid. During backflow, the oil remains in the membrane, which may at least partially lift from the surface of the sand filter during the backflow.

In some embodiments, treating the mixture with the membrane includes filtering the mixture through the membrane to generate a water permeate. For instance, the mixture can be poured onto the membrane under atmospheric pressure. As the mixture passes through the membrane, the membrane acts as a barrier, allowing water and smaller solutes to permeate while retaining larger particles, contaminants, or oils. This separation occurs due to the membrane's specific pore structure and material properties, which are designed to facilitate selective filtration. The resulting permeate is a clarified water solution, free from larger impurities, making it suitable for various applications, including reuse in industrial processes, environmental management, or even as pre-treated water for further purification methods.

In some embodiments, the mixture may include hexane, dodecane, crude oil, brackish water, heptane, octane, decane, nonane, cyclohexane, toluene, xylene, gasoline, kerosene, diesel, mineral oil, petroleum ether, light aromatic hydrocarbons or a combination thereof. In a preferred embodiment, the mixture includes Saudi crude oil and non-polar organic solvents (e.g. n-hexane and dodecane).

In some embodiments, the membrane may exhibit significant adsorption capacities for crude oil within the range of 30-60 g g⁻¹ (e.g. 30 g g⁻¹, 35 g g⁻¹, 40 g g⁻¹, 45 g g⁻¹, 50 g g⁻¹, 55 g g⁻¹, 60 g g⁻¹ or any values therebetween). In a preferred embodiment, the membrane exhibits an adsorption capacity for crude oil of 58.4 g g⁻¹.

In some embodiments, the membrane can be mechanically regenerated by squeezing the membrane after the membrane has been used to treat a water and oil mixture. This process removes the absorbed oil and contaminants, restoring the membrane's filtration capacity without damaging its structure. After squeezing out the absorbed substances, the regenerated membrane is ready to be reused for treating another mixture of water and oil. This regeneration method allows for multiple cycles of use, enhancing the membrane's efficiency and lifespan, while maintaining its performance for continuous oil-water separation applications.

In some embodiments, the membrane may have a recovery rate of 50%-90% (e.g. 50%, 60%, 70%, 80%, 90% or any values therebetween) after five cycles of use and regeneration. In a preferred embodiment, the membrane has a recovery rate of about 75% even after five cycles of use and regeneration.

### EXAMPLES

The following examples demonstrate a method of water treatment. The examples are provided solely for illustration and are not to be construed as limitations of the present disclosure, as many variations are possible without departing from the spirit and scope of the present disclosure.

### Example 1: Materials

2,4,6-Trimethyl-m-phenylenediamine (TrMPD), bisphenol A dianhydride (BPADA), dimethylformamide (DMF), dodecane, toluene, hexane, m-cresol, and isoquinoline were purchased from Merck. Crude oil (Arabian light from Saudi Aramco) was used as received.

### Example 2: Polyimide Synthesis

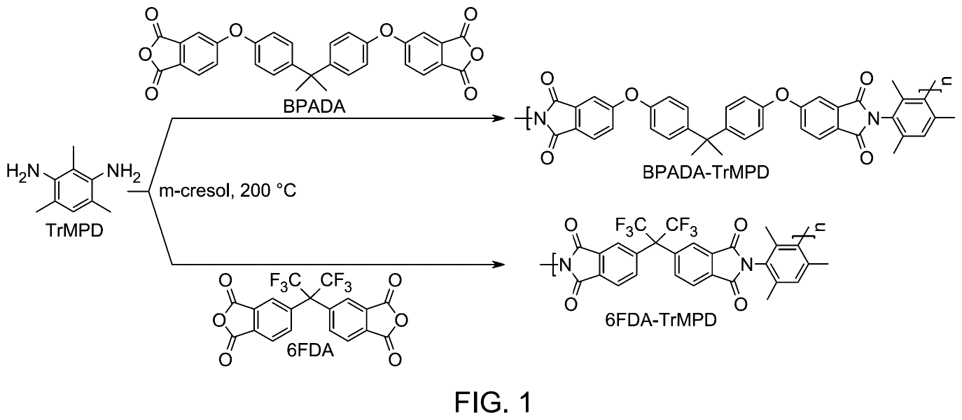

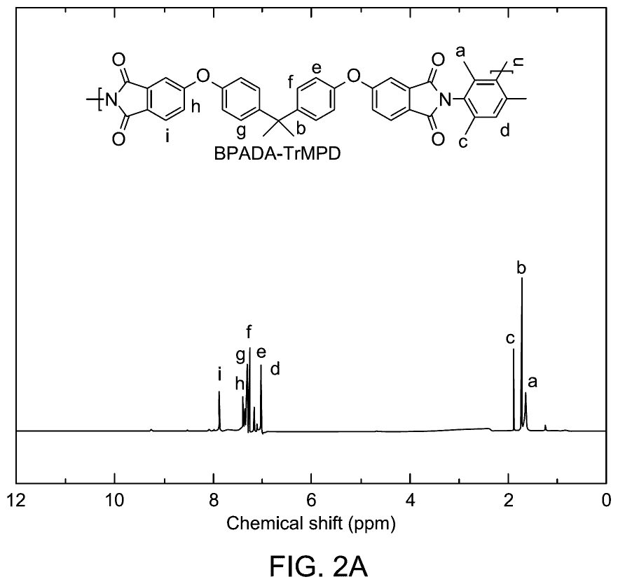

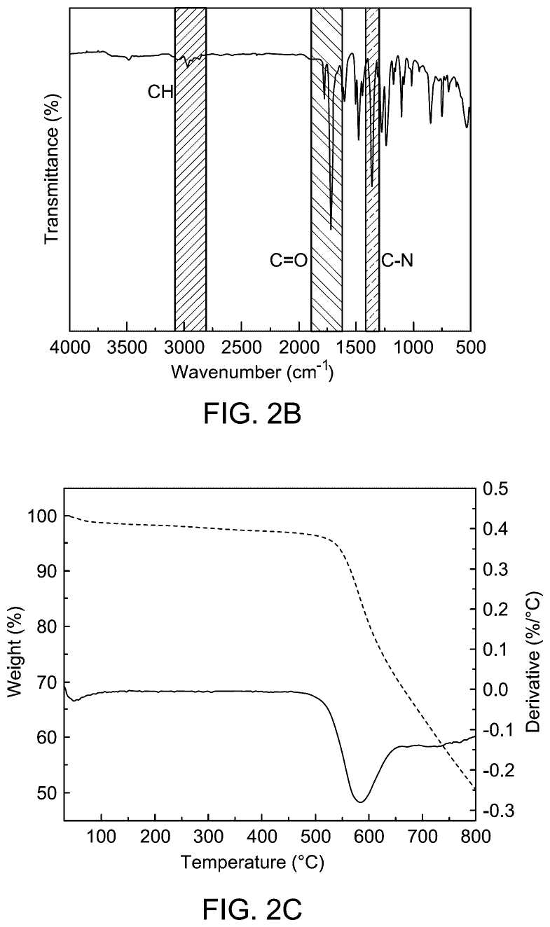

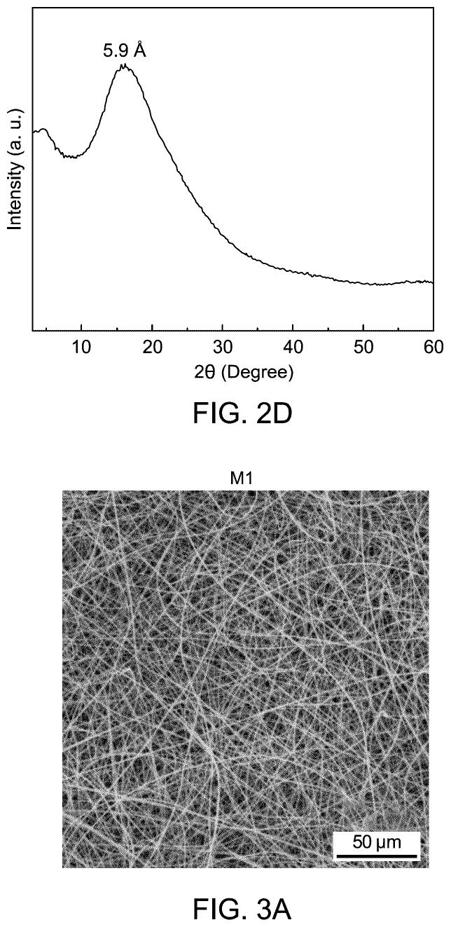

BPADA-TrMPD was synthesized via a one-step polycondensation reaction between the BPADA and the TrMPD using a procedure as shown in FIG. 1 (F. Topuz and coworkers, Hierarchically porou selectrospun nanofibrous mats produced from intrinsically microporous fluorinated polyimide for the removal of oils and non-polar solvents, Environ Sci Nano, 2020, 7, 5, 1365-1372, incorporated herein by reference in its entirety). An equimolar ratio of BPADA and TrMPD was mixed with m-cresol in a two-neck round bottom flask in the presence of an inert atmosphere of nitrogen gas (N₂). The reaction temperature was raised gradually to 100° C., where 0.1 mL of isoquinoline was added. Afterward, the reaction temperature was gradually increased to 200° C. and kept for 4 hours (h). The resulting polymer was then precipitated by methanol and stirred for 6 h. The obtained fibrous material was filtered off, washed with methanol three times, and dried at 150° C. for 24 h under vacuum. The proton nuclear magnetic resonance (¹H NMR) spectrum of BPADA-TrMPD is shown in FIG. 2A and listed as follows: (400 MHZ, CDCl₃): δ (ppm) 1.65 (s, 3H), 1.73 (s, 6H), 1.89 (s, 6H), 7.02 (d, 4H, J=5.6 Hz), 7.16 (s, 1H), 7.31 (d, 4H, J=5.6 Hz), 7.34 (m, 2H), 7.39 (m, 2H), 7.87 (d, 2H, J=5.6 Hz). Further, the Fourier transform infrared (FTIR) spectrum of BPADA-TrMPD is shown in FIG. 2B and listed as follows: (cm⁻¹) 2972 (—C—H, str), 1776 (C═O asym, str), 1717 (C═O sym, str), 1355 (C—N, str). Mn=24,400 g mol⁻¹, Mw=54,500 g mol⁻¹, PDI=2.2.

### Example 3: Membrane Fabrication

Fabrication of the membrane started with preparing 20 wt. % of the BPADA-TrMPD polymer solution by dissolving BPADA-TrMPD in dimethylformamide (DMF) under continuous stirring for 3 h, followed by removing gas bubbles using an incubator shaker. The solution was then electro-spun using an injection rate of 0.5 milliliters per hour (mL h⁻¹), voltage of 16 kV, tip-to-collector distance of 10 cm, and collected on an aluminum foil attached to a stationary or rotating drum with a rotation speed of 150 rpm. The temperature was kept at 21° C., and the relative humidity was about 50% to 55%, as listed in Table 1. The membranes were collected and dried at 120° C. for 24 h to remove the residual DMF.

TABLE 1
Electrospinning conditions for the 20 wt. % BPADA-
TrMPD-based electrospun nanofibrous membranes.

| | | Tip-to- | | Drum | Average fiber | |
|---|---|---|---|---|---|---|
| | Voltage | collector | Injection rate | speed | diameter | Water contact |
| Membrane | (kV) | (cm) | (mL h⁻¹) | (rpm) | (nm) | angle (°) |
| M1 | 16 | 10 | 0.5 | 0 | 760 ± 310 | 114.4 ± 3.6 |
| M2 | 16 | 10 | 0.5 | 150 | 1450 ± 650 | 114.7 ± 0.17 |

The chemical structure of the BPADA-TrMPD was evaluated using FTIR spectroscopy, performed with a Bruker INVENIO series FTIR spectrometer in the range of 400 cm⁻¹ to 4000 cm⁻¹. The ¹H-NMR spectrum was collected from Bruker AVANCE-III spectrometer (400 MH2) in CDCl₃. Gel permeation chromatography (GPC) was used to obtain molecular weight (Mw), number-average-molecular weight (Mₙ), and polydispersity index (PDI) by using DMF as an eluent. The thermal properties of the BPADA-TrMPD after electrospinning were acquired using thermal gravimetric analysis (TGA) at a rate of 5° C. min⁻¹ and up to 800° C. Wide-angle X-ray diffraction (WXRD) patterns were collected by a Mini-Flex 600 in the 20 range of 5° to 60°. The morphology of the membranes before and after oil adsorption experiments was evaluated by scanning electron microscopy (SEM) (JEOL JCM-7000). Surface wettability measurements, including evaluation of water contact angle (WCA) and oil contact angle (OCA), were performed using a computer-controlled sigma force tensiometer (Biolin Scientific) in triplicate, and the average results were listed. The density of the solvents, crude oil and emulsions was measured using Anton Paar Densimeter (DMA 4500), while the viscosity was measured using Anton Paar Rheometer (MCR 702). The microscopic images of the emulsions before and after filtration were captured with an optical microscope (Olympus BX51, Olympus Stream Essential software).

### Example 4: Oil Adsorption Test

The oil uptake efficiency of the BPADA-TrMPD-based membranes was determined as follows: the electrospun membranes were cut into square pieces (20±0.5 mg) and immersed into crude oil at room temperature, then the mass of each membrane was measured as a function of exposure time. Oil sorption capacity (Cₛₒᵣₚ) was calculated by equation (1):

$${C}_{sorp} ( g {g}^{- 1} ) = \frac{{m}_{t} - {m}_{0}}{{m}_{0}} \qquad ( 1 )$$

Where “m₀” (g) and “mₜ” (g) represent the masses of the BPADA-TrMPD membranes before and after the oil uptake test, respectively.

### Example 5: Membrane Performance

A sand core filtration system is used to conduct the flux test without emulsion separation, where the BPADA-TrMPD membranes are placed on the top of the sand core. The crude oil, n-hexane, dodecane, and two surfactant free-stabilized without emulsions were poured into the sand core filter. The membrane flux (J) was calculated by measuring the volume of oil passing through the membrane per unit of time and membrane area using equation (2):

$$J ( L {m}^{- 2} {h}^{- 1} ) = \frac{V}{A \times Δ t} \qquad ( 2 )$$

where “V” (liters) is the permeate volume, “A” (m²) is the effective area of the membrane, and “Δt” (hours) is the permeation time.

### Example 6: Optical Microscope Analysis

Optical microscopy was utilized for emulsion analysis. Emulsion images were captured using an Olympus BX51 microscope equipped with Olympus stream essential software. A droplet of the emulsion was carefully pipetted onto a glass slide after gently shaking the bottle. The emulsion was spread thinly on the slide by allowing it to stand vertically briefly. Cover glasses were omitted to prevent alterations in droplet size. Samples were examined at 20 times magnification.

### Example 7: Recyclability Test

Mechanical regeneration by squeezing the membrane under pressure was employed to evaluate its stability and durability. The membrane was used for five cycles, and its oil sorption capacity was measured.

### Results

BPADA-TrMPD was synthesized via a one-step polycondensation reaction using an equimolar ratio of the bisphenol A dianhydride (BPADA) and the diamine (TrMPD), as shown in FIG. 1. The chemical structure of the polyimide was confirmed by ¹H-NMR spectroscopy, as shown in FIG. 2A. The absence of peaks in the region above 10 parts per million (ppm) indicated the absence of the acidic O—H protons of carboxylic groups and confirmed the full conversion of poly (amic acid) to polyimide, as previously reported (Z. A. AlDhawi and coworkers, Carboxyl-functionalized polyimides for efficient bisphenol A removal: Influence of wettability and porosity on adsorption capacity, Chemosphere, 2023, 313, 134347, incorporated herein by reference in its entirety). Further, FTIR spectroscopy was utilized to identify the functional groups of BPADA-TrMPD, as shown in FIG. 2B. The imide group absorption bands were found at approximately 1776 cm⁻¹ (C═O asym, str), 1717 cm⁻¹ (C═O sym, str) and 1355 cm⁻¹ (C—N, str) confirming the successful synthesis of the BPADA-TrMPD polymer.

The resulting polymer exhibited excellent solubility in organic solvents and good stability in alcohols and water, similar to the previously reported 6FDA-TrMPD, as listed in Table 2. The results show the potential of developing solution-processable polyimides without the usage of fluorinated monomers such as 6FDA. Furthermore, the desirable solubility in DMF allows the polymer to transfer into nanofibrous membranes by electrospinning. Moreover, BPADA-TrMPD displayed high Mw of about 54,500 g mol⁻¹, which supports membrane formation during electrospinning.

TABLE 2
Solubility tests of BPADA-TrMPD in different solvents. 6FDA-TrMPD is included
for comparison (F. Topuz and coworkers, Hierarchically porou selectrospun
nanofibrous mats produced from intrinsically microporous fluorinated polyimide
for the removal of oils and non-polar solvents, Environ Sci Nano, 2020,
7, 5, 1365-1372, incorporated herein by reference in its entirety).

| | Solvent | | | | | | | | | | |
|---|---|---|---|---|---|---|---|---|---|---|---|
| | | | | | | | | | | | m- |
| Polymer | H₂O | MeOH | EtOH | Acetone | DMF | DMSO | DMAc | NMP | THF | CHCl3 | cresol |
| BPADA | − | − | − | − | + | + | + | + | + | + | + |
| 6FDA- | − | − | − | + | + | + | + | + | + | + | + |
| TrMPD | | | | | | | | | | | |

The thermogravimetric analysis (TGA) was conducted to evaluate the thermal stability of the BPADA-TrMPD, as shown in FIG. 2C. BPADA-TrMPD exhibited excellent thermal stability with a 5% weight loss obtained at T_{d,5%}=541° C., which is 41° Chigher than the thermal stability of 6FDA-TrMPD with a T_{d,5%}=500° C. However, both polymers revealed similar residual weights of about 50% at 700° C. The excellent thermal stability of the BPADA-TrMPD demonstrates its high potential to replace 6FDA-based polyimides for applications that require high thermal stability. Further, the morphology of the BPADA-TrMPD was investigated using WXRD patterns and compared to 6FDA-TrMPD. BPADA-TrMPD displayed one main broad peak at 14.9° corresponding to a d-spacing value of 5.9 Å (FIG. 2D). The results were similar to those obtained for 6FDA-TrMPD (F. Topuz and coworkers, Hierarchically porou selectrospun nanofibrous mats produced from intrinsically microporous fluorinated polyimide for the removal of oils and non-polar solvents, Environ Sci Nano, 2020, 7, 5, 1365-1372, incorporated herein by reference in its entirety), in which both BPADA-TrMPD and 6FDA-TrMPD exhibit amorphous structure with a low degree of crystallinity compared to the conventional PIs which is mainly attributed to the extended chain length along with aliphatic isopropylidene group, ether linkages and the contortion of the starting monomers (F. Topuz and coworkers, Advances in polymers of intrinsic microporosity (PIMs)-based materials for membrane, environmental, catalysis, sensing and energy applications, Polym. Rev., 2024, 64, 1, 251-305).

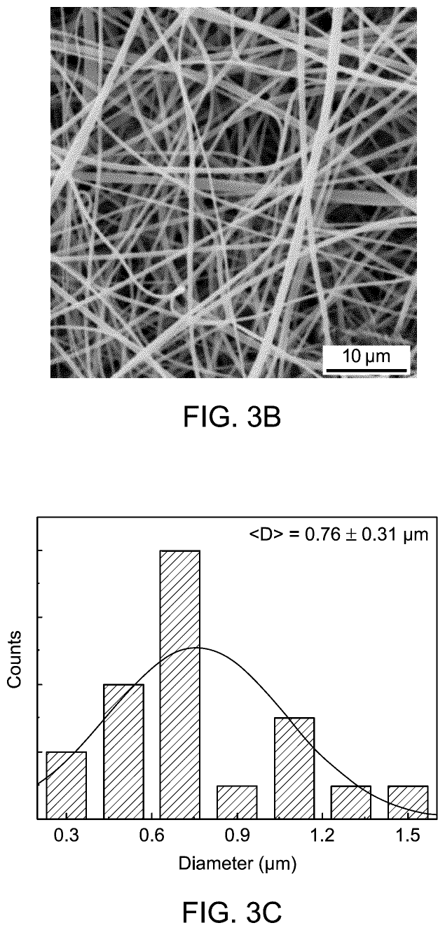

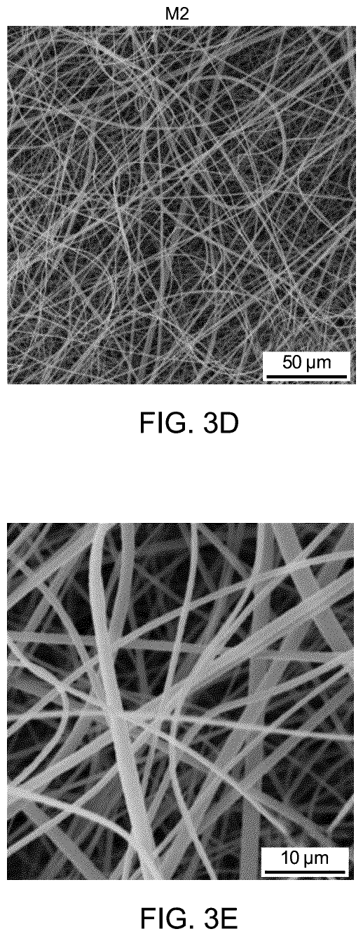

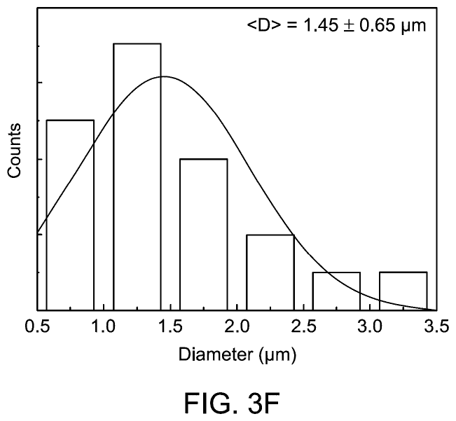

The nanofibrous membranes were prepared from 20 wt. % of the polymer solution of BPADA-TrMPD in DMF using an electrospinning technique. The resulting membranes exhibited porous structure and bead-free fibers with a mean diameter of (760±310) nm and (1450±650) nm, and M2, respectively, as shown by SEM, depicted in FIGS. 3A-3F and Table 1. The membranes exhibited the ability to be folded without experiencing any cracks, demonstrating structural stability even under deformation, likely attributed to the high molecular weight of the BPADA-TrMPD polymer.

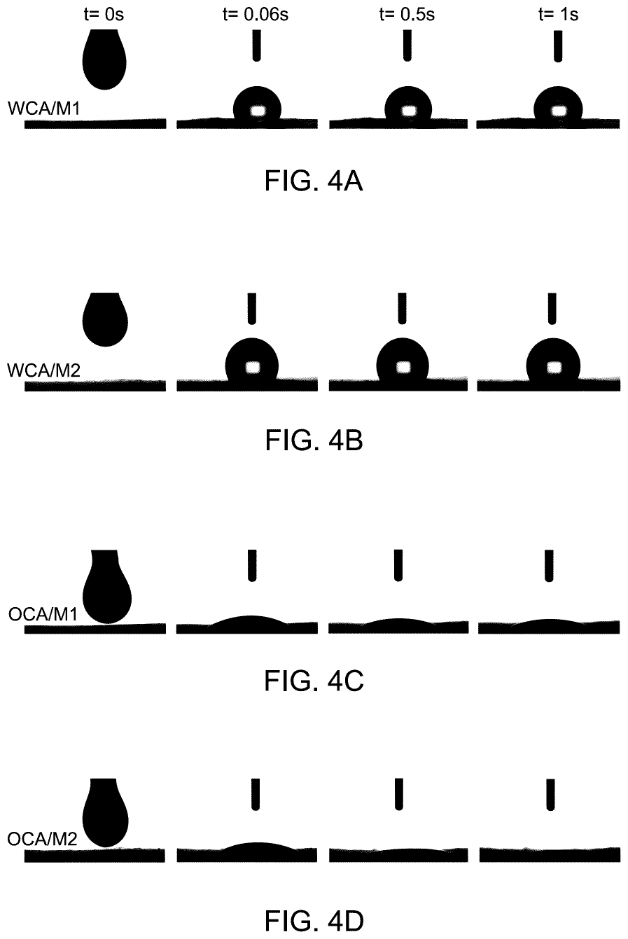

The wettability of the membranes was evaluated using WCA and OCA, as presented in FIGS. 4A-4D. Both membranes M1 and M2, displayed similar WCA of about 114.4°±3.6° and 114.7°±0.17°, respectively, indicating the hydrophobic nature of the fluorine-free BPADA-TrMPD polymer, as shown in FIGS. 4A-4B. Furthermore, the oil contact angle (OCA) was measured in dynamic mode over 1 second for both membranes, as shown in FIGS. 4C-4D. The membranes demonstrated fast adsorption of the crude oil in which the droplet disappears after 1 second, which indicates the great potential of utilizing BPADA-TrMPD-based electro spun nanofibrous membranes for rapid oil spill removal.

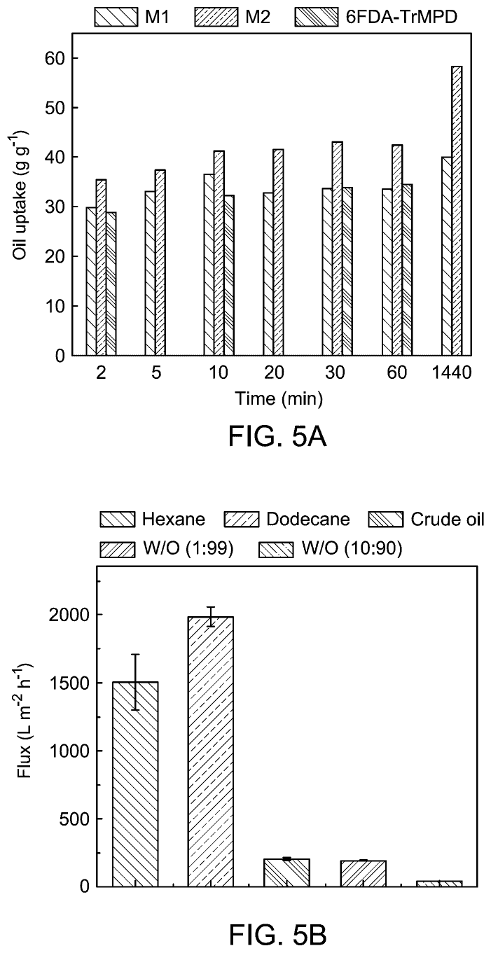

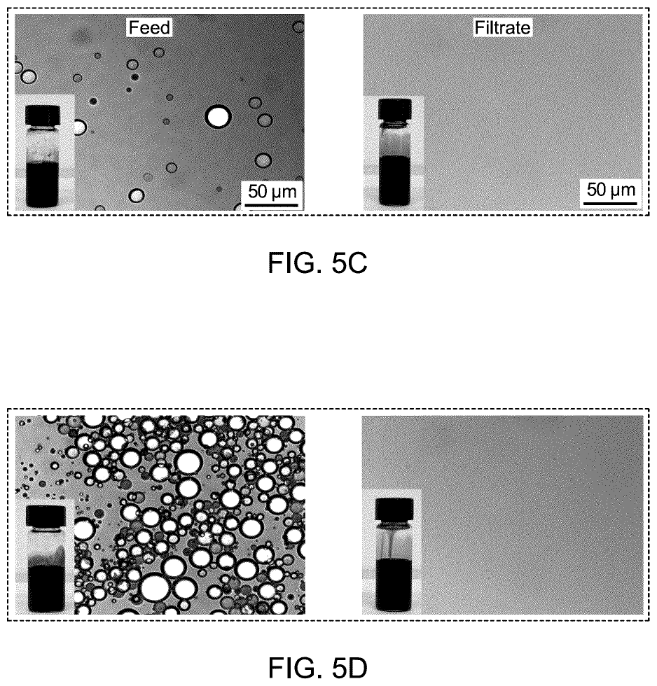

The rapid uptake of crude oil, as evidenced by dynamic contact angle measurements, indicates the potential for oil absorption into the membrane fibers. To assess the efficacy of the newly developed membranes, oil uptake experiments were conducted over a 24-hour period, as detailed in previous literature (F. Topuz and coworkers, Hierarchically porou selectrospun nanofibrous mats produced from intrinsically microporous fluorinated polyimide for the removal of oils and non-polar solvents, Environ Sci Nano, 2020, 7, 5, 1365-1372, incorporated herein by reference in its entirety) and shown in FIGS. 5A-5D. As can be seen from FIGS. 5A-5D, the membranes M1 and M2 demonstrated oil adsorption capacities of 29.8 g g⁻¹ and 35.5 g g⁻¹, respectively, after 2 minutes of immersion, as shown in FIG. 5A. It may be noted that membranes based on BPADA-TrMPD electro spun nanofibers exhibited slightly higher oil uptake compared to those based on 6FDA-TrMPD. In particular, after 2 minutes of soaking, M1 exhibited comparable performance to 6FDA-TrMPD, with an oil adsorption capacity of approximately 29 g g⁻¹, while M2 demonstrated a 22% increase in adsorption capacity relative to the 6FDA-TrMPD-based polymer. Conversely, after 1 hour of soaking, M1 maintained a similar performance to 6FDA-TrMPD, with an adsorption capacity of approximately 34 g g⁻¹, while M2 showed a 21% higher oil uptake. Furthermore, as the contact time increased from 2 minutes to 1440 minutes, the adsorption capacities increased by 34% from about 29.8 g g⁻¹ to about 40 g g 1 and 64%, from about 35.5 g g⁻¹ to about 58.4 g g⁻¹, for M1 and M2, respectively. The obtained results demonstrated that using the rotating drum at a speed of 150 rpm as a collector may significantly improve the fiber diameter and the oil adsorption capacity relative to the stationary collector. Hence, it may be concluded that the 6FDA-based polymers may be replaced with the BPADA-TrMPD polyimide for rapid oil spill removal.

In order to further assess the efficiency of newly developed fluorine-free polyimide-based membranes for oil spill treatment, the present disclosure further includes flux measurements using various solvents, including Saudi Arabia crude oil, n-hexane, dodecane, and crude oil/water emulsions at two different ratios including an oil-to-water (o/w) ratios of 99/1 and 90/10, employing M2, as shown in FIGS. 5C-5D. Pure hydrocarbons exhibited notable flux of (1991±62) L m⁻² h⁻¹ and (1507±213) L m⁻² h⁻¹ for dodecane and n-hexane, respectively. However, a significantly lower flux of (206±11) L m⁻² h⁻¹ was observed for crude oil, likely due to its high density and viscosity, which enhance oil adhesion to the fibers, thus impeding diffusion and flux, as listed Table 3. For example, hexane displayed a viscosity of 0.31 cP at 100 S⁻¹, while crude oil showed a viscosity of 4.73 cP at 100 S⁻¹, which was 15 times higher.

In order to corroborate this observation, crude o/w emulsions were prepared at various o/w ratios, revealing higher density and viscosity compared to crude oil, as listed in Table 3. At an o/w ratio of 99/1, the solution displayed a viscosity of 6.32 cP at 100 S⁻¹, and M2 exhibited an oil flux of (195±5) L m 2 h⁻¹, only 5% lower than that of pure crude oil. Conversely, a substantial decrease in flux was noted for the emulsion at an o/w ratio of 90/10, with a crude oil flux of 43 L m 2 h⁻¹, representing a 79% reduction compared to pure crude oil. The reduction may be attributed to the significant increase in viscosity, which hinders crude oil diffusion through the nanofibrous membrane.

TABLE 3
The density and viscosity of different solvents and emulsions

| Permeates | Density (g mL⁻¹) at 25° C. | Viscosity (cP at 100 S⁻¹) |
|---|---|---|
| 0.659 | 0.31 | 0.659 |
| 0.75 | 1.374 | 0.75 |
| 0.818 | 4.73 | 0.818 |
| 0.859 | 6.32 | 0.859 |
| 0.891 | 6.89 | 0.891 |

In order to assess the BPADA-TrMPD-based separation efficiency of the membranes, the separation of crude oil/water emulsions were monitored using an electron microscopy. FIGS. 5C-5D display images of the emulsion before and after separation, respectively. It is evident that the emulsion with an o/w ratio of 99/1 contained micro-sized water droplets, as shown in FIG. 5C, which were absent after membrane filtration. Similarly, in the case of the 90/10 ratio, microscopic examination after membrane filtration revealed only crude oil, indicating complete rejection of water molecules by the membrane, as shown in FIG. 5D.

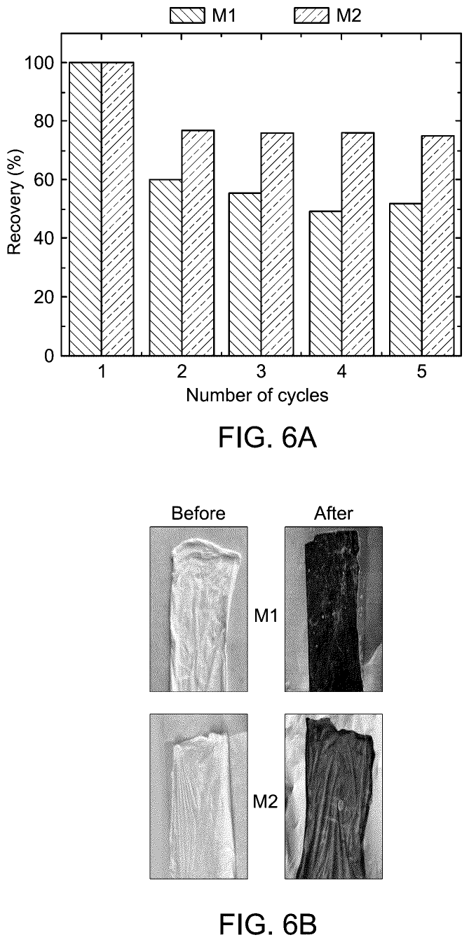

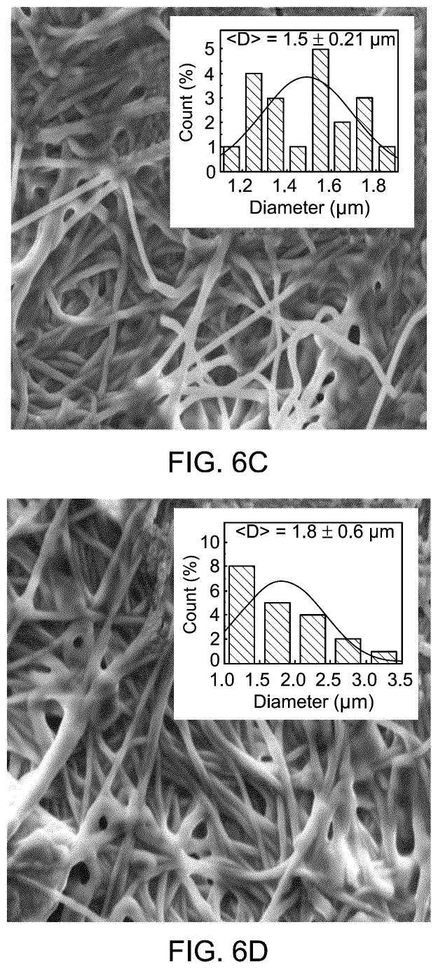

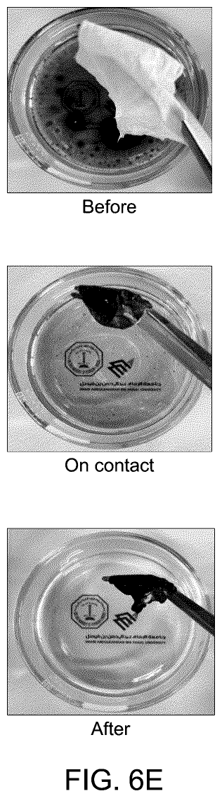

Additionally, the reusability of the nanofibrous membranes was assessed over five cycles using mechanical regeneration, and the resulting performance is presented in FIG. 6A. It may be noted that M2 exhibited higher performance than M1 due to larger fiber diameter size and higher initial oil uptake corresponding to M2. After five cycles, M2 maintained more than 75% recovery. Further, the membranes M1 and M2 exhibited stable mechanical properties after regeneration, with no cracking or damage observed, as shown in FIG. 6B. SEM images of the membranes before and after regeneration showed compaction of fibers and loss of porosity due to the pressure applied during mechanical regeneration with no cracking, as shown in FIGS. 6C-6D.

Furthermore, the application of M2 in real-world scenarios was evaluated, particularly in addressing oil spills in seawater. This involved testing an efficacy of the M2 in removing crude oil from a mixture of seawater and the crude oil. The results revealed that M2 successfully accomplished this task, yielding clean water in less than 2 minutes, as shown in FIG. 6E. The rapid and effective oil removal emphasizes the potential practical utility of the membrane in mitigating environmental pollution events caused by oil spills in marine environments.

In order to further explore the efficacy of fluorine-free polyimides in oil spill treatment, the crude oil uptake of BPADA-TrMPD was compared with that of previously reported polymers and materials, listed in Table 4. 6FDA-DABA and BPADA-TrMPD exhibited superior crude oil uptake compared to other fluorinated polyimide-based membranes. Additionally, BPADA-TrMPD-based membranes demonstrated significantly higher adsorption capacities for crude oil when compared to other materials, such as cellulose-based aerogel and silicon oxide fibers. The findings highlight the potential of fluorine-free polyimides to achieve comparable or even enhanced performance compared to fluorine-containing polymers. The reduced use of fluorine offers desirable implications for environmental conservation and sustainability efforts.

TABLE 4
Crude oil sorption performance of BPADA-TrMPD-based nanofibrous
membranes relative to various polymeric adsorbents.

| | | Sorption capacity | |
|---|---|---|---|
| Sorbent | Material form | (g g⁻¹) | Ref. |
| BPADA-TrMPD | Nanofibrous mat | 58.4 | This work |
| 6FDA-TrMPD | Nanofibrous mat | 34.6 | 1* |
| 6FDA-DMN | Nanofibrous mat | 29.5 | 2* |
| 6FDA-TrMCA | Nanofibrous mat | 39 | 2* |
| 6FDA-DABA | Nanofibrous mat | 61.8 | 2* |
| 6FDA-mPDA | Nanofibrous mat | 53.6 | 2* |
| SiO2 decorated | Fibers | 57 | 3* |
| cotton fibers | | | |
| Cellulose-based | Aerogel | 20.5 | 4* |
| aerogels | | | |

1* (F. Topuz and coworkers, Hierarchically porou selectrospun nanofibrous mats produced from intrinsically microporous fluorinated polyimide for the removal of oils and non-polar solvents, Environ Sci Nano, 2020, 7, 5, 1365-1372, incorporated herein by reference in its entirety)
2* (F. Topuz and coworkers, Superoleophilic oil-adsorbing membranes based on porous and nonporous fluorinated polyimides for the rapid remediation of oils pills, Chem, Eng. J, 2022, 449, 137821, incorporated herein by reference in its entirety)
3* (N. Lv and coworkers, Superhydrophobic/superoleophilic cottonoilabsorbent: preparation and its application in oil/water separation, RSC Advances, 2018, 8, 30257-30264, incorporated herein by reference in its entirety)
4* (S. T. Nguyen and coworkers, Cellulose Aerogel from Paper Waste for Crude Oil Spill Cleaning, Industrial & Engineering Chemistry Research, 2013, 52, 18386-18391, incorporated herein by reference in its entirety)

According to aspects of the present disclosure, hydrophobic electro spun nanofibrous membranes derived from fluorine-free polyimide have been successfully fabricated. The synthesis process involved a one-step polycondensation reaction, resulting in a polymer with remarkable solubility in organic solvents and exceptional thermal stability, surpassing 500° C. in decomposition temperature. The membranes M1 and M2 exhibited significant adsorption capacities for crude oil within the range of 30 g g⁻¹ to 58 g g⁻¹, alongside impressive flux rates for crude oil, dodecane, and n-hexane, measured at (206±11) Lm⁻² h⁻¹, (1991±62) L m 2 h⁻¹, and (1507±213) L m 2 h⁻¹, respectively. Notably, the membranes demonstrated excellent water rejection, effective emulsion separation, and maintained stability and recyclability, with recovery rates exceeding 75% even after five cycles of use and mechanical regeneration. The production scalability, achievable through industrial electro spinners, suggests the potential for large-scale applications in mitigating oil and chemical leakages, with improved sorption measurements showing an increase of about 58 times their initial weights. These findings underline the promising utility of these membranes in addressing environmental challenges associated with oil and chemical spills.

Numerous modifications and variations of the present disclosure are possible in light of the above teachings. Therefore, it is to be understood that within the scope of the appended claims, the invention may be practiced other than as specifically described herein.

1. A method of water treatment, comprising:
treating a mixture of water and oil with a membrane that comprises a polyimide formed by polycondensation between 4,4′(4,4′-isopropylidenediphenoxy)bis-(phthalic anhydride) (BPADA) and 2,4,6-trimethyl-m-phenylenediamine (TrMPD),
wherein the polyimide does not include fluorine,
the polyimide is in the form of fibers having an average diameter of 0.5-5.0 μm, and
the fibers are bead-free and form pores having an average size of 2-10 μm.

2. The method of claim 1, wherein the treating the mixture with the membrane comprises:
soaking the membrane in the mixture for a period of 0.1-5.0 minutes to absorb 10-40 grams of the oil from the mixture per 1 gram of the membrane; and
removing the membrane from the mixture to obtain purified water.

3. The method of claim 2, wherein:
about 35.5 grams of the oil per 1 gram of the membrane is absorbed from the mixture by the membrane for the period of 2 minutes.

4. The method of claim 1, further comprising:
forming the membrane by electrospinning a solution comprising the polyimide on a drum at a rotating speed of 0-500 rpm,
wherein the treating includes contacting the mixture with the membrane to pass an oil-free permeate through the membrane, and
wherein a back surface of the membrane is supported on a loose particle filter.

5. The method of claim 4, wherein:
the solution further comprises dimethylformamide as a solvent,
the polyimide is present at a concentration of 15-25 wt. % based on a total weight of the solution, and
the rotating speed is 0-150 rpm.

6. The method of claim 5, wherein:
the polyimide is present at a concentration of 20 wt. % based on the total weight of the solution, and
the rotating speed is 150 rpm.

7. The method of claim 6, wherein:
a volage of the electrospinning is 16 kV,
an injection rate of the electrospinning is 0.5 mL/h,
a tip-to-collector distance is 10 cm, and
a temperature of the electrospinning is 21° C.

8. The method of claim 1, wherein:
the membrane has an oil contact angle of about 0°.

9. The method of claim 8, wherein:
the membrane has a water contact angle of 110° or more and 160° or less.

10. The method of claim 1, wherein:
the polyimide has a weight molecular weight of 40,000 to 80,000 g/mol.

11. The method of claim 1, wherein:
the polyimide includes 70 to 100 mass % of repeating units based on 4,4′-(4,4′-isopropylidenediphenoxy)bis-(phthalic anhydride) (BPADA) and 2,4,6-trimethyl-m-phenylenediamine (TrMPD), relative to a total weight of repeating units of the polyimide.

12. The method of claim 11, wherein:
the polyimide includes 100 mass % of repeating units based on 4,4′-(4,4′-isopropylidenediphenoxy)bis-(phthalic anhydride) (BPADA) and 2,4,6-trimethyl-m-phenylenediamine (TrMPD), relative to the total weight of the repeating units of the polyimide.

13. The method of claim 1, wherein:
the polyimide has no carboxylic group.

14. The method of claim 1, wherein:
the polyimide includes 0 to 5 mass % of repeating units based on benzoxazole, benzimidazole, benzothiazole, 4,4′-biphenyltetracarboxylic acid dianhydride, 4,4′-diaminodiphenyl ether, polybenzoxazine, silica nanoparticles, p-phenylene diamine or a combination thereof, relative to a total weight of repeating units of the polyimide.

15. The method of claim 1, wherein:
the polyimide does not include repeating units based on benzoxazole, benzimidazole, benzothiazole, 4,4′-biphenyltetracarboxylic acid dianhydride, 4,4′-diaminodiphenyl ether, polybenzoxazine, silica nanoparticles or p-phenylene diamine.

16. The method of claim 1, wherein:
the membrane includes 0-10 mass % of nanoparticles of oxides, metallic compounds or both, relative to a total weight of the membrane.

17. The method of claim 1, wherein the treating the mixture with the membrane comprises:
filtering the mixture through the membrane to generate a water permeate.

18. The method of claim 17, wherein the filtering comprises:
pouring the mixture onto the membrane under atmospheric pressure.

19. The method of claim 1, further comprising:
mechanically regenerating the membrane by squeezing the membrane after the treating; and
treating another mixture of water and oil with the membrane after the mechanically regenerating.

20. The method of claim 1, wherein:
the mixture comprises hexane, dodecane, crude oil, brackish water or a combination thereof.
